(19) United States
(12) Patent Application Publication
(10) Pub. No.: US 2009/0313142 A1
(43) Pub. Date: Dec. 17, 2009

(54) INFORMATION PROVIDING DEVICE, COMPUTER-READABLE RECORDING MEDIUM, AND STORE SYSTEM

(75) Inventors: Akio Hiruma, Shizuoka (JP); Kenya Hiramatsu, Shizuoka (JP); Kenji Shimizu, Shizuoka (JP); Takahide Kubota, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/482,575

(22) Filed: Jun. 11, 2009

(30) Foreign Application Priority Data
Jun. 12, 2008 (JP) 2008-154696

(51) Int. Cl. G06Q 10/00; G08B 13/14; G06F 17/30

(52) U.S. Cl. 705/28; 340/568.8; 235/385; 707/104.1; 707/E17.009

(57) ABSTRACT

An information terminal displays a coordinate screen acquired from a coordinate database on a liquid crystal display, acquires data of an article code of clothes coordinated in the coordinate image from the coordinate database, acquires data of inventory status and display status associated with the acquired article code from an inventory database which stores and saves an article code of an individual article in association with inventory status of the article in a warehouse and display status of the article in a sales floor, and displays an inventory screen which reports a place where the article exists as an article inventory list on the liquid crystal display.

### CROSS REFERENCE TO RELATED APPLICATION

This application is based upon and claims the benefit of priority from Japanese Patent Application No. 2008-154696, filed on Jun. 12, 2008, the content of which is incorporated herein by reference.

### TECHNICAL FIELD

The present invention relates to an information providing device which stores and saves a coordinate image formed by picking up an image of coordinated clothes and provides the stored and saved coordinate image to a customer, a computer program used for this, and a store system configured to include the information providing device.

### BACKGROUND

Nowadays, as a sales pattern at a boutique, it becomes common that a shop assistant coordinates and tries on clothes that are sold at its store or affiliated store and thus makes the article including the coordinate taste appeal to customers.

JP-A-2005-099891 discloses a technique of registering coordinate information and collating and displaying the registered coordinate information. JP-A-2005-099891 also discloses displaying coordinate information that is rearranged on the basis of information about the presence or absence of inventory, and real-time update of the presence or absence of inventory managed at the head office in accordance with the sales of articles. The device disclosed in JP-A-2005-099891 makes an inquiry to a head office computer about the presence or absence of individual articles in stock included in the coordinate information, and displays inventory information received from the head office, notifies customers of the inventory information via email, or provides information on a dedicated web page for customers.

A store which handles clothes may have a warehouse attached to its sales floor. Therefore, articles in stock may be those displayed in the sales floor or those stored in the warehouse. The display in the sales floor includes the case of displaying articles on shelves in a state that allows customers to look at the articles and the case of storing articles in drawers attached to the shelves. Therefore, when providing inventory information on individual articles to customers, if only the information about the presence or absence of articles in stock and the number of stocked articles is provided to the customers, the customers cannot reach the place where the articles are present.

### SUMMARY

It is an object of the invention to accurately show the status of articles in the sales floor and the warehouse attached to the sales floor.

According to an aspect of the invention, an information providing device includes a display unit for displaying information, an operation input unit for carrying out operation input of information, and a controller which executes information processing. The controller executes processing to (i) acquire data of a coordinate image from a coordinate database which stores and saves a coordinate image formed by picking up an image of coordinated clothes as an article in association with an articles code of the coordinated clothes in the coordinate image, (ii) display a coordinate screen including the acquired coordinate image on the display unit, (iii) acquire data of an article code of the coordinated clothes in the coordinate image included in the coordinate screen, from the coordinate database, (iv) acquire data of inventory status in a warehouse and data of display status in a sales floor associated with the acquired article code, from an inventory database which stores and saves an article code of an individual article in association with inventory status of the article in a warehouse and display status of the article in a sales floor, and (v) display, on the display unit, an inventory screen which reports a place where the article exists on the basis of the acquired data of inventory status and display status.

According to another aspect of the invention, a computer-readable medium having a computer program stored thereon which, when executed by a computer, will cause the computer to execute the above processing (i) to (v).

According to still another aspect of the invention, a store system includes the above information providing device, an entrance reader as an RFID reader which can be installed at an entrance of a warehouse in such a manner that data can be transmitted to and received from the information providing device and which acquires an article code from a wireless tag attached to clothes via short-range wireless communication, and an exit reader as an RFID reader which can be installed at a doorway between the warehouse and a sales floor in such a manner that data can be transmitted to and received from the information providing device and which acquires an article code from a wireless tag attached to clothes via short-range wireless communication. The controller of the information providing device executes processing to (vi) if the information providing device receives an article code that is data-transmitted from the entrance reader, increment the number of articles stocked in the warehouse by one with respect to that article, as update management of an inventory database which stores and saves an article code of an individual article in association with the number of articles stocked in the warehouse and the number of articles displayed in the sales floor with respect to that article, and (vii) if the information providing device receives an article code that is data-transmitted from the exit reader, decrement the number of articles stocked in the warehouse by one and increment the number of articles displayed in the sales floor by one with respect to that article, as update management of the inventory database, in addition to the above processing (i) to (v)

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram showing the overall configuration of a system as an embodiment of the invention;

FIG. 2 is a schematic view schematically showing basic processing contents in a coordinate information registration phase, a coordinate information browse phase and a data transmission and reception phase;

FIG. 3 is a schematic view of a store showing the positions of installation of an RFID reader, an entrance reader, an exit reader and a store reader in the store;

FIG. 4 is a block diagram showing electric connection of an information terminal;

FIG. 5 is a schematic view showing recording data in an article master area recorded on an HDD of the information terminal;

FIG. 6 is a schematic view showing recording data in a shop assistant master area recorded on the HDD of the information terminal;

FIG. 7 is a schematic view showing recording data in a customer master area recorded on the HDD of the information terminal;

FIG. 8 is a schematic view showing recording data in a meta image accumulation area recorded on the HDD of the information terminal;

FIG. 9 is a schematic view showing recording data in a coordinate information area recorded on the HDD of the information terminal;

FIG. 10 is a schematic view showing recording data in an inventory management master area recorded on the HDD of the information terminal;

FIG. 11 is a schematic view showing recording data in a display position management area recorded on the HDD of the information terminal;

FIG. 12 is a schematic view showing recording data in a display position image area recorded on the HDD of the information terminal;

FIG. 13 is a block diagram showing electric connection of a POS terminal;

FIG. 14 is a flowchart showing a flow of coordinate information registration;

FIG. 15 is a schematic view showing an exemplary coordinate edit screen displayed on a liquid crystal display of the information terminal;

FIG. 16 is a schematic view showing an exemplary coordinate edit screen after a coordinate image is displayed on the liquid crystal display of the information terminal and after a shop assistant code and an article code are entered;

FIG. 17 is a flowchart showing a flow of coordinate information browse;

FIG. 18 is a schematic view showing an exemplary coordinate list screen displayed on the liquid crystal display of the information terminal;

FIG. 19 is a schematic view showing an exemplary tag information standby screen displayed on the liquid crystal display of the information terminal;

FIG. 20 is a schematic view showing an exemplary coordinate-by-article list screen displayed on the liquid crystal display of the information terminal;

FIG. 21 is a schematic view showing an exemplary coordinate screen displayed on the liquid crystal display of the information terminal;

FIG. 22 is a flowchart showing a flow of inventory confirmation;

FIG. 23 is a flowchart showing a flow of display of an article inventory list;

FIG. 24 is a flowchart showing a flow of display of inventory details;

FIG. 25 is a schematic view showing an exemplary inventory screen;

FIG. 26 is a schematic view showing an exemplary inventory details screen; and

FIG. 27 is a schematic view showing an exemplary display position screen.

### DETAILED DESCRIPTION

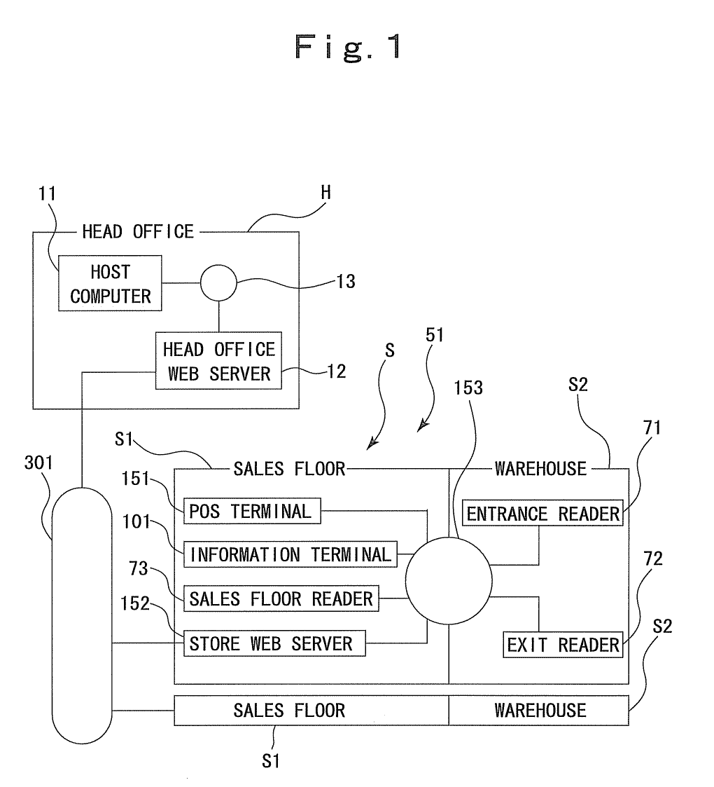

An embodiment of the invention will be described with reference to FIG. 1 to FIG. 27.

### 1. Basic Configuration

FIG. 1 is a block diagram showing the overall configuration of a system. The system has a host computer 11 installed in a head office H and a store system 51 installed in an individual store S. The host computer 11 is connected to the store system 51 in such a manner that data can be transmitted and received via a communication network 301. The head office H has a head office web server 12 in addition to the host computer 11. The host computer 11 and the head office web server 12 are connected to each other in such a manner that data can be transmitted and received between each other via a local area network (LAN) 13. In the store S, a store web server 152 is installed which is connected to the communication network 301 and controls data communications. The store web server 152 and various devices are connected to each other via a local area network 153.

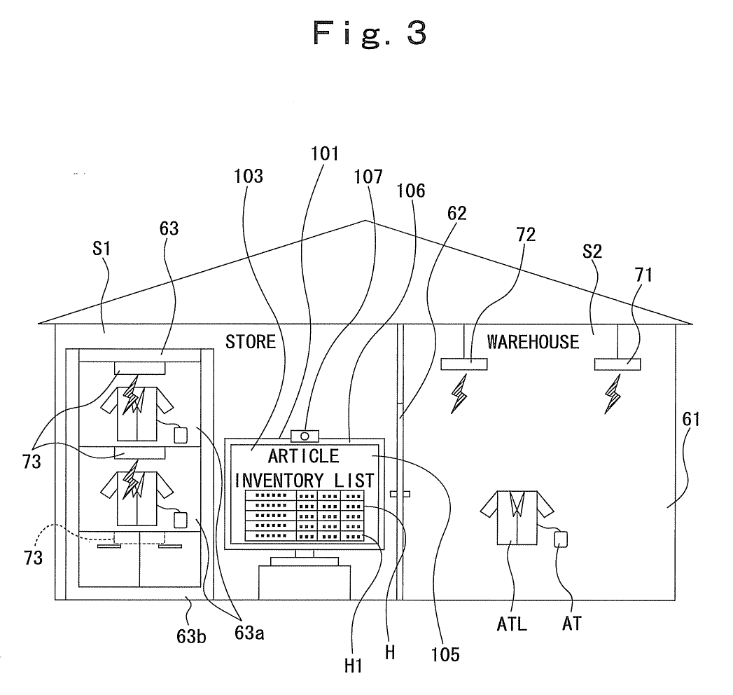

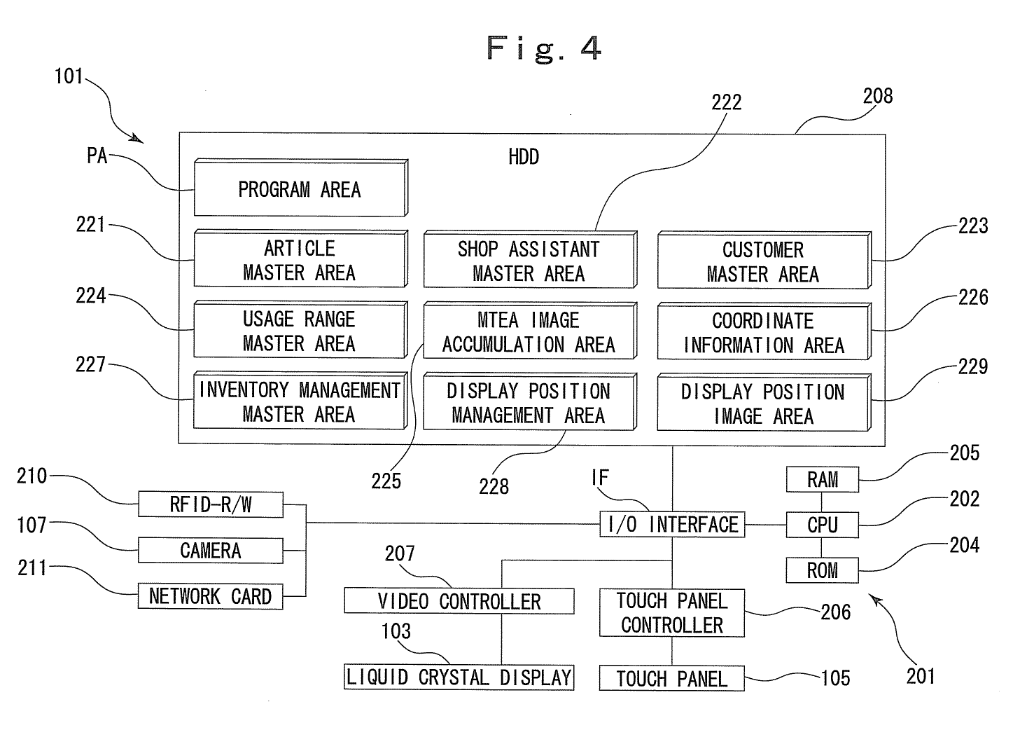

The store S has a sales floor S1 and a warehouse S2 attached to the sales floor S1. In the sales floor S1, an information terminal 101 as an information providing device, a POS terminal 151, a sales floor reader 73 and the store web server 152 are installed. The warehouse S2 has an entrance reader 71 installed at its entrance 61 (see FIG. 3) and an exit reader 72 installed at its doorway 62 (see FIG. 3 and FIG. 4). The sales floor reader 73, the entrance reader 71 and the exit reader 72 are RFID reader writers.

An article ATL in the store S has an article tag AT containing an RFID chip which stores an article ID (article code) for specifying the article ATL. The RFID reader writer and the RFID contained in the article tag AT carry out short-range wireless communication based on electromagnetic induction using a 13.56-MHz band and short-range wireless communication using a UHF band.

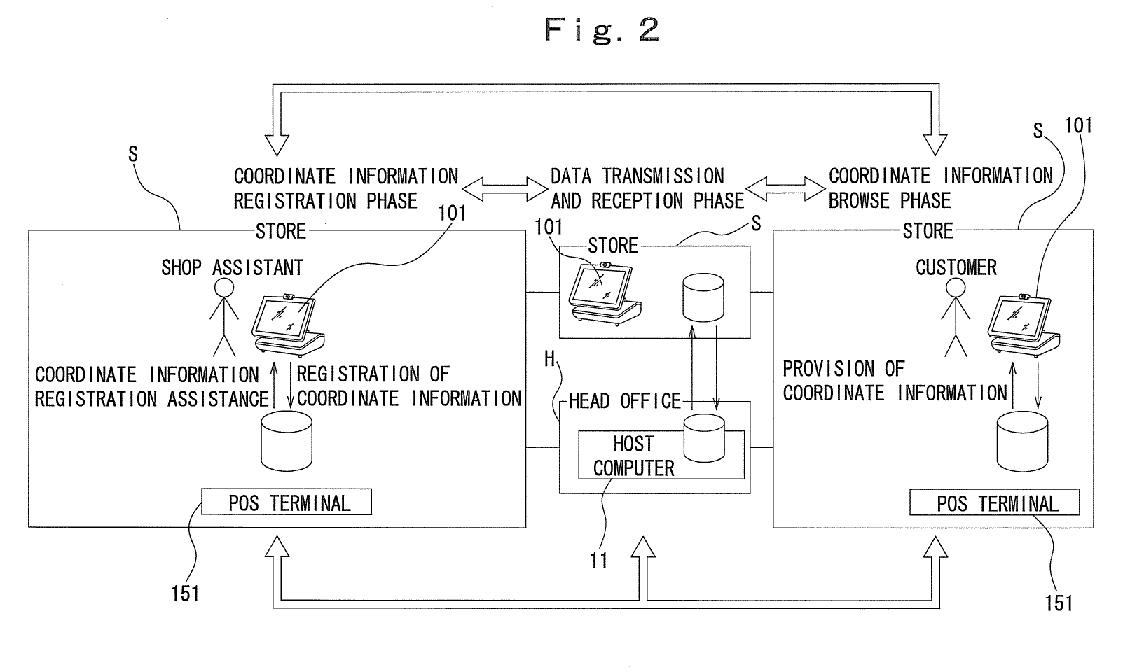

FIG. 2 is a schematic view schematically showing basic processing contents in a coordinate information registration phase, a coordinate information browse phase and a data transmission and reception phase. The store system 51 contributes to execution of the coordinate information registration phase and the coordinate information browse phase. Data communications between the store system 51 and the host computer 11 contribute to execution of the data transmission and reception phase.

In the coordinate information registration phase, registration of coordinate information created by a shop assistant using the information terminal 101 is accepted. Coordinate information includes a coordinate image formed by picking up an image of clothes that are sold at the store S or another store S and coordinated by the shop assistant, a shop assistant code specifying the shop assistant who acts as a model for the clothes, and an article code specifying clothes which are coordinated and tried on.

In the coordinate information browse phase, a customer is provided with browsing of the coordinate information by using the information terminal 101. The information terminal 101 provides the customer with the coordinate information registered in the coordinate information registration phase.

In the coordinate information browse phase, a coordinate image is provided to the customer and inventory information of the clothes coordinated in the coordinate image is provided.

In the data transmission and reception phase, sales data generated by the POS terminal 151 at individual stores S are transmitted to the host computer 11 in the head office H via the store web server 152. The host computer 11 in the head office H stores, saves and manages the sales data gathered from the individual stores S and creates inventory information about each store S based on the sales data. The host computer 11 transmits the created inventory information to the information terminal 101 of the individual stores S. Thus, all the stores S can share the inventory information of each store S. It is desirable that data transmission and reception of sales data and inventory information in the data transmission and reception phase is executed in real time. As an alternative example, data transmission and reception may be carried out by batch processing at night after the operation at the individual shops S is finished.

FIG. 3 is a schematic view of the store S. The store S has the sales floor S1 connected to the warehouse S2 via the doorway 62. The entrance reader 71 and the exit reader 72 are installed in the warehouse S2. The article ATL is first carried into the warehouse S2 and stored in the warehouse S2. The entrance reader 71 executes wireless communication with the article tag AT attached to the article ATL carried in from the entrance 61, and thus acquires the article code. The shop assistant moves the article ATL from the warehouse S2 to the sales floor S1 via the doorway 62 when necessary. The exit reader 72 is installed at the doorway 62 between the sales floor S1 and the warehouse S2. The exit reader 72 executes wireless communication with the article tag AT attached to the article ATL moved to the sales floor S1 from the doorway 62 and thus acquires the article code of the article.

In the sales floor S1, a display rack 63, the information terminal 101, the POS terminal 151 (see FIG. 1), the sales floor reader 73 and the store web server 152 (see FIG. 1) are installed. The display rack 63 has a display area 63a and a drawer 63b. In the sales floor S1, the shop assistant displays the article ATL moved from the warehouse S2, in the display area 63a of the display rack 63, or houses the article ATL in the drawer 63b provided in the lower part of the display rack 63.

The sales floor reader 73 is installed at plural positions in the display area 63a and the drawer 63b of the display rack 63. The sales floor reader 73 executes wireless communication with the article tag AT attached to the article ATL displayed in the display area 63a of the display rack 63 or housed in the drawer 63b and thus acquires the article code of the article.

The information terminal 101 has a liquid crystal display 103, a touch panel 105 provided on the display surface of the liquid crystal display 103, and a camera 107 provided at an upper part of a frame 106 of the liquid crystal display 103.

FIG. 4 is a block diagram showing electric connection of the information terminal 101. As shown in FIG. 4, the information terminal 101 has a microcomputer 201. This microcomputer 201 drive-controls each part. The microcomputer 201 is connected to a ROM 204 and a RAM 205 and constitutes a controller that executes information processing.

The microcomputer 201 is connected to an input-output (I/O) interface IF. The I/O interface IF provides connection to a touch panel controller 206, a video controller 207, an HDD 208, an RFID reader writer 210, the camera 107, and a network card 211.

The touch panel controller 206 is connected to the touch panel 105 and takes an input signal from the touch panel 105 into the microcomputer 201.

The video controller 207 is connected to the liquid crystal display 103 and drive-controls the liquid crystal display 103.

The HDD 208 has a program area PA, an article master area 221, a shop assistant master area 222, a customer master area 223, a usage range master area 224, a meta image accumulation area 225, a coordinate information area 226, an inventory management master area 227, a display position management area 228 and a display position image area 229.

The RFID reader writer 210 wirelessly communicates with an RFID chip. In this embodiment, the shop assistant holds an ID card (not shown) containing an RFID chip which stores a shop assistant code as an identification code. The article ATL has an article tag AT attached thereto containing an RFID chip which stores an article code for specifying the article ATL. The customer holds a member card (not shown) containing an RFID chip which stores a customer code as an identification code. The RFID reader writer 210 receives the shop assistant code specifying the shop assistant from the ID card held by the shop assistant. The RFID reader writer 210 also receives the article code specifying the article ATL from the article tag AT attached to the article ATL. The RFID reader writer 210 also receives the customer code specifying the customer from the member card held by the customer. The RFID reader writer 210 outputs the received shop assistant code, article code and customer code. The microcomputer 201 takes in the shop assistant code, the article code and the customer code outputted from the RFID reader writer 210.

As an alternative example, the shop assistant code specifying the shop assistant and the customer code specifying the customer may be inputted through the touch panel 105 on the liquid crystal display 103. As another example, a shop assistant code and a customer code expressed as code symbols such as bar code or two-dimensional code may be prepared and the shop assistant code and the customer code may be inputted by optically scanning these code symbols with a code reader.

The camera 107 picks up an image of a shop assistant as a subject and outputs image pickup data. The microcomputer 201 takes in the image pickup data outputted from the camera 107.

The network card 211 is a data transmitting and receiving unit for mutual data communications between the POS terminal 151 and the store web server 152, and the information terminal 101.

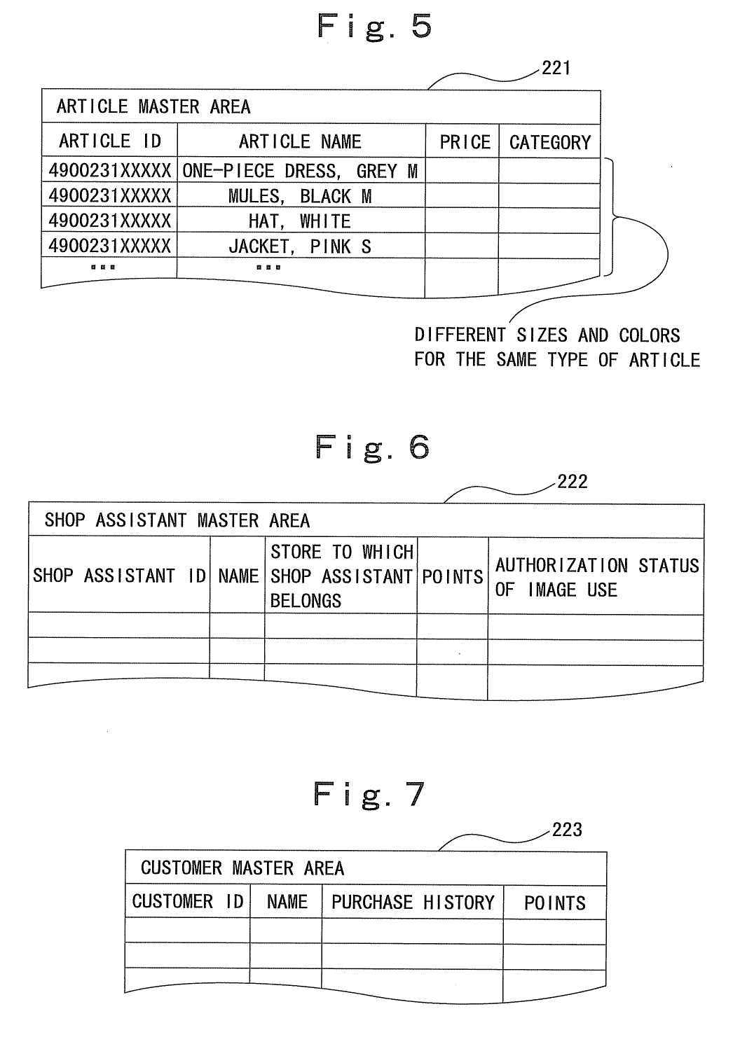

FIG. 5 is a schematic view showing recording data in the article master area 221 (article database) recorded on the HDD 208 of the information terminal 101. The article master area 221 stores article IDs (article codes) specifying individual articles ATL in association with their article names. In the article master area 221, different article codes are given to articles of different sizes and difference colors with the same article name, but a part of the article codes is common. The common code part identifies the same article name, that is, the same article ATL.

FIG. 6 is a schematic view showing recording data in the shop assistant master area 222 recorded on the HDD 208 of the information terminal 101. The shop assistant master area 222 stores a shop assistant code specifying a shop assistant to be a subject, the name of the subject, the store to which the subject belongs, points, and authorization status of image use in association with each other. The information terminal 101 specifies the shop assistant code when the shop assistant logs in.

FIG. 7 is a schematic view showing recording data in the customer master area 223 recorded on the HDD 208 of the information terminal 101. The customer master area 223 stores a customer ID (customer code) specifying a customer, the customer's name, purchase history, and points in association with each other. The information terminal 101 specifies the customer code when the customer logs in.

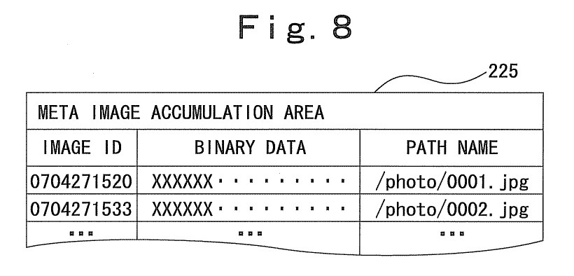

FIG. 8 is a schematic view showing recording data in the meta image accumulation area 225 recorded on the HDD 208 of the information terminal 101. The meta image accumulation area 225 stores an image ID specifying a coordinate image picked up by the camera 107, data of the coordinate image (binary data), and its path name in association with each other. The coordinate image is an image formed by picking up, with the camera 107, an image of clothes sold at a store S or another store S and coordinated by a shop assistant.

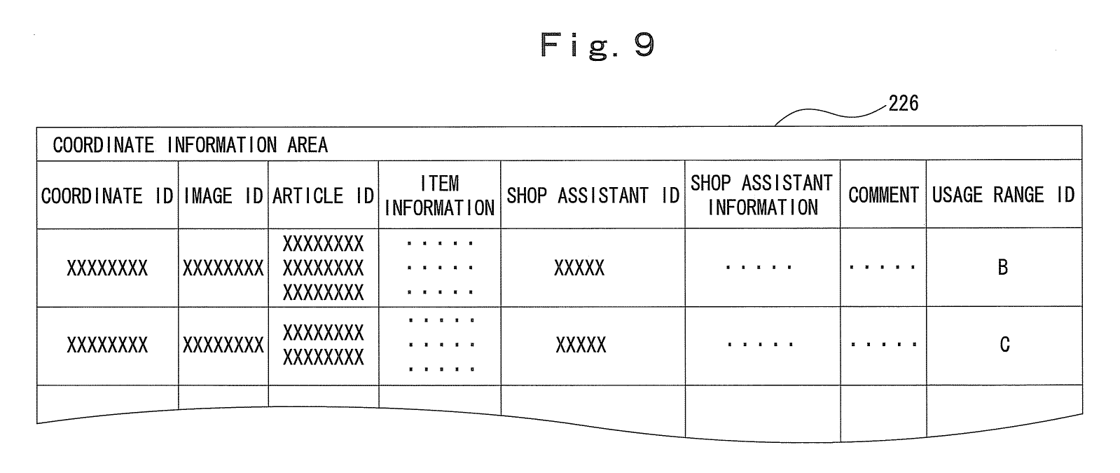

FIG. 9 is a schematic view showing recording data in the coordinate information area 226 recorded on the HDD 208 of the information terminal 101. The coordinate information area 226 stores a coordinate ID specifying a coordinate, an image ID, an article code, item information, a shop assistant ID, shop assistant information (the name and store to which the shop assistant belongs), and a comment in association with each other.

Therefore, the meta image accumulation area 225 and the coordinate information area 226 construct a coordinate database in which a coordinate image formed by picking up an image of coordinated clothes as an article ATL is stored and saved in association with the article ID (article code) of the clothes coordinated in the coordinate image.

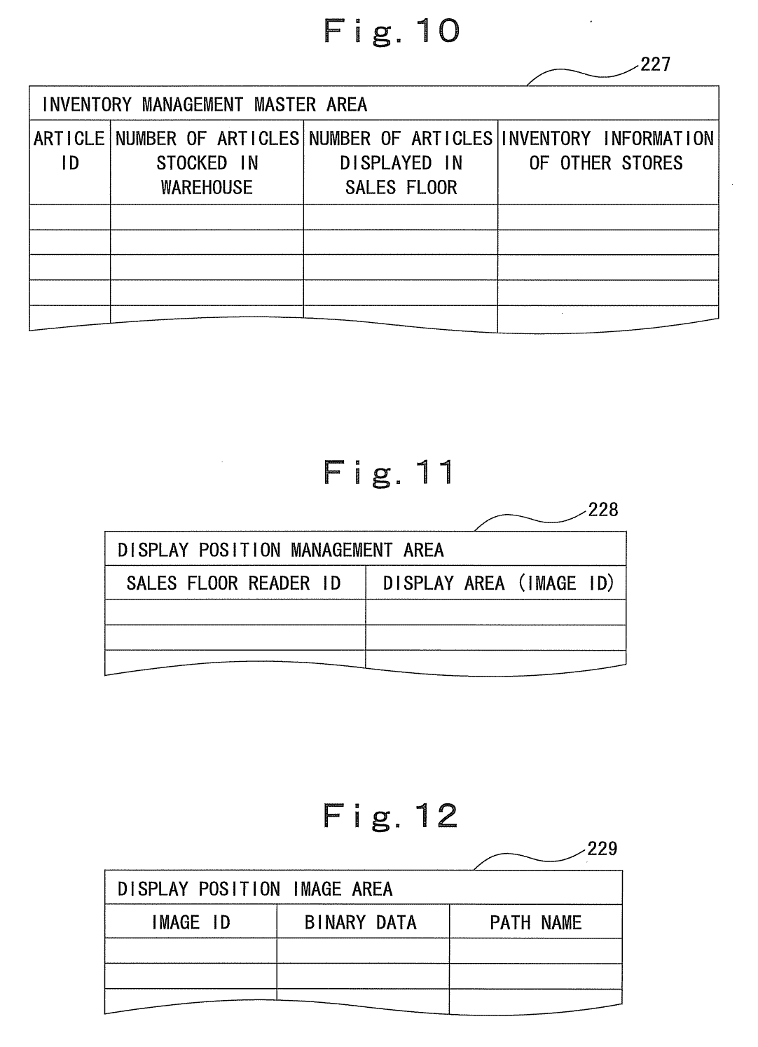

FIG. 10 is a schematic view showing recording data in the inventory management master area 227 recorded on the HDD 208 of the information terminal 101. The inventory management master area 227 stores an article code, the number of articles stocked in the warehouse, the number of articles displayed in the sales floor, and inventory information of other stores in association with each other.

As certain clothes as an article ATL are carried in from the entrance 61 of the warehouse S2, the entrance reader 71 executes wireless communication with the article tag AT attached to the clothes that are carried in, and thus acquires the article code.

The entrance reader 71 attaches a univocal IP address specifying itself to the acquired article code and transmits this to the information terminal 101. The entrance reader 71 stores a sequence for executing such processing in a storage unit (not shown). As the article code from the entrance reader 71 specified by the IP address is received, a CPU 202 of the information terminal 101 increments the number of articles stocked in the warehouse in the inventory management master area 227 by one. This is because the number of the articles ATL stocked in the warehouse S2 is increased by one.

As the clothes as the article ATL stocked in the warehouse S2 are moved from the warehouse S2 to the sales floor S1 via the doorway 62, the exit reader 72 executes wireless communication with the article tag AT attached to the moved clothes and thus acquires the article code.

The exit reader 72 attaches a univocal IP address specifying itself to the acquired article code and transmits this to the information terminal 101. The exit reader 72 stores a sequence for executing such processing in a storage unit (not shown). As the article code from the exit reader 72 specified by the IP address is received, the CPU 202 of the information terminal 101 decrements the number of articles stocked in the warehouse in the inventory management master area 227 by one and increments the number of articles displayed in the sales floor by one. This is because the number of the articles ATL stocked in the warehouse S2 is decreased by one and the number of the articles ATL displayed in the store S is increased by one.

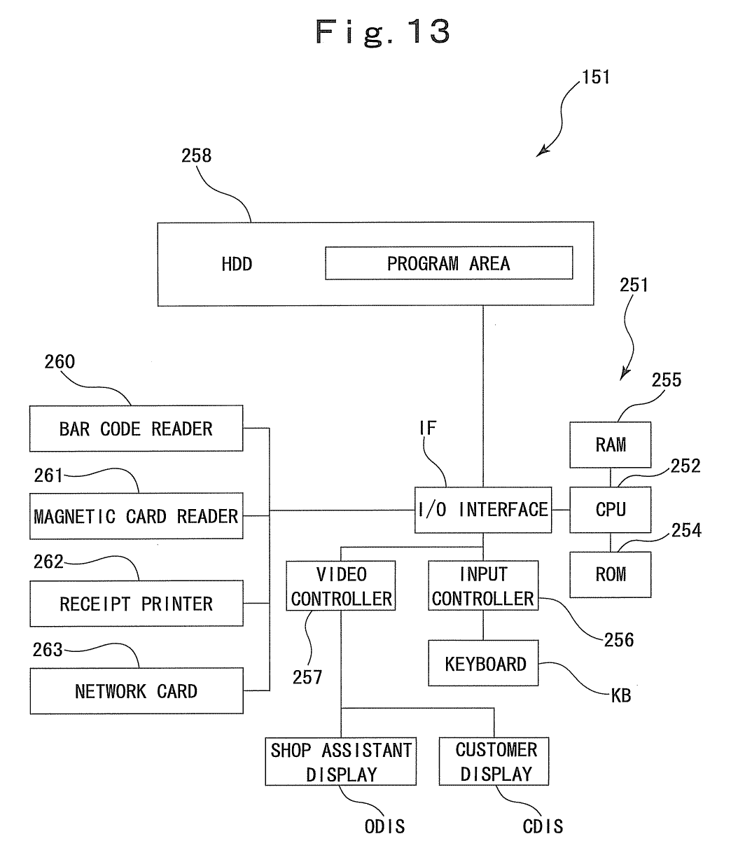

As settlement is executed, a microcomputer 251 of the POS terminal 151 (see FIG. 13) transmits the article code of the article ATL for which settlement is completed, as a settlement report to the information terminal 101. The POS terminal 151 has a computer program for executing such processing, installed in a program area PA of its HDD 258 (see FIG. 13). As the settlement report from the POS terminal 151 is received, the microcomputer 201 of the information terminal 101 decrements the number of articles displayed in the sales floor in the inventory management master area 227 by one. This is because the number of the articles ATL displayed (stocked) in the store S is decreased by one.

The inventory information of other stores is based on inventory information transmitted from the host computer 11 in the data transmission and reception phase described with reference to FIG. 2. This inventory management master area 227 constructs an inventory database in which article IDs as article codes of individual articles ATL, the inventory status of the articles ATL in the warehouse S2, and the display status in the sales floor S1 are stored and saved in association with each other.

FIG. 11 is a schematic view showing recording data in the display position management area 228 recorded on the HDD 208 of the information terminal 101. The display position management area 228 stores and saves sales floor reader IDs specifying the plural sales floor readers 73 installed in the sales floor S1 in association with the display area (image ID). The store system 51 specifies the position of an article ATL placed in the sales floor S1 on the basis of the arrangement position of the sales floor reader 73 which scans its article code.

FIG. 12 is a schematic view showing recording data in the display position image area 229 recorded on the HDD 208 of the information terminal 101. The display position image area 229 stores an image ID specifying images such as photographs or illustrations expressing the sales floor S1, image data of these images, and their path names in association with each other.

An image expressing the sales floor S1 is prepared for every place where the sales floor reader 73 is installed. Images expressing sales floor S1 are display position images including information showing the scanning area on the rack by the individual sales floor readers 73. As a display area (image ID) is searched for on the basis of a sales floor reader ID indicating a specific sales floor reader 73 by search from the display position management area 228 shown in FIG. 11, the information terminal 101 carries out search from the display position image area 229 and thus searches for image data associated with the image ID that is searched for. By this search, the information terminal 101 can reach an image that specifies the position where the article ATL is placed, from the individual sales floor readers 73.

FIG. 13 is a block diagram showing electric connection of the POS terminal 151. The microcomputer 251, a ROM 254 and a RAM 255 constitute a controller which executes information processing. The POS terminal 151 has an I/O interface IF connected to the microcomputer 251. The I/O interface IF connects an input controller 256, a video controller 257, an HDD 258, a bar code reader 260, a magnetic card reader 261, a receipt printer 262, and a network card 263 to the microcomputer 251.

The HDD 258 has an OS and programs for merchandise sales data processing installed in a program area.

The input controller 256 connected to the I/O interface IF takes in a signal from a keyboard KB.

The video controller 257 connected to the I/O interface IF controls a shop assistant display ODIS and a customer display CDIS.

The bar code reader 260 connected to the I/O interface IF optically scans a code symbol (not shown) such as a bar code printed on an article tag AT attached to individual articles ATL.

The network card 263 connected to the I/O interface IF connects the microcomputer 251 to the local area network 153. The network card 263 is a data transmitting and receiving unit for mutual data communications between the POS terminal 151 and the store web server 152, and the information terminal 101.

### 2. Coordinate Information Registration Phase

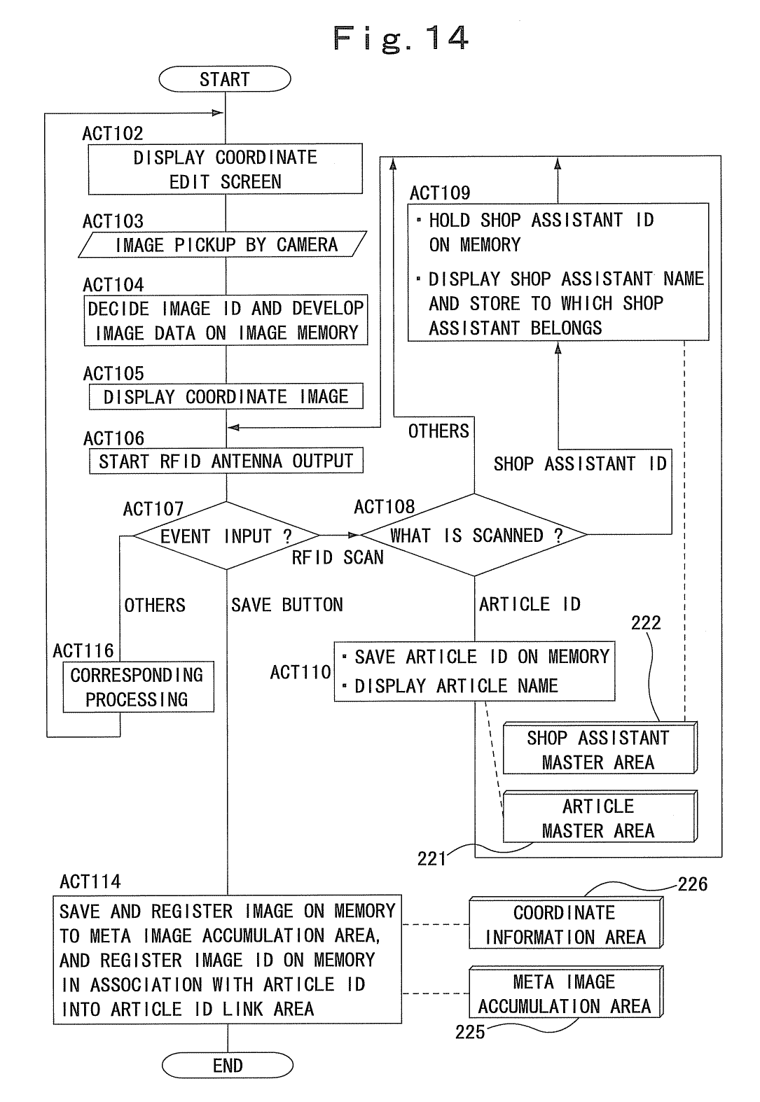

FIG. 14 is a flowchart showing the flow of coordinate information registration. The programs installed in the program area PA of the HDD 208 of the information terminal 101 include a program for coordinate information registration in order to accumulate and register image data picked up by the camera 107 and an external camera 212, into the meta image accumulation area 225 and the coordinate information area 226.

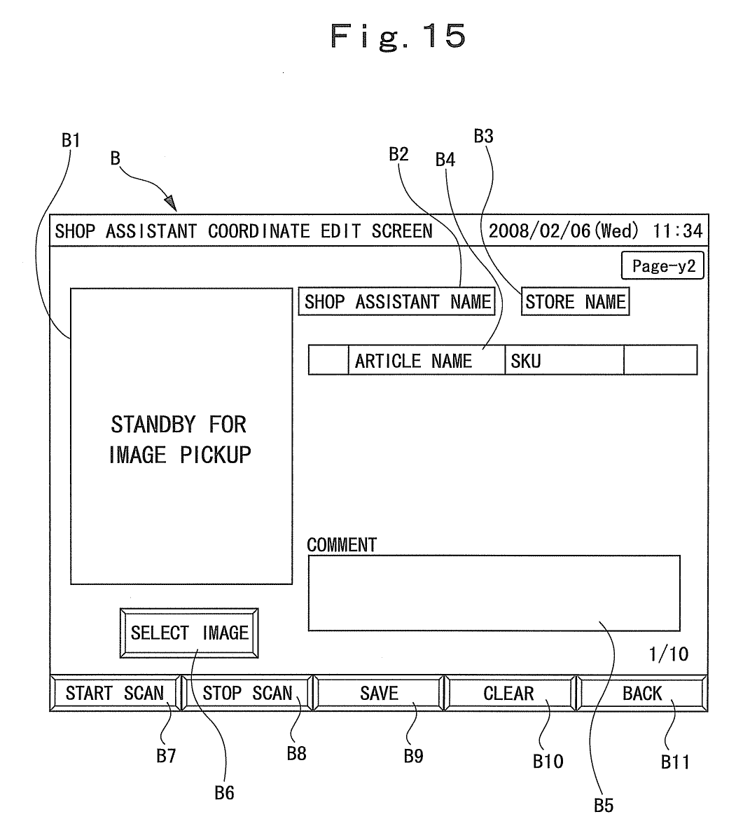

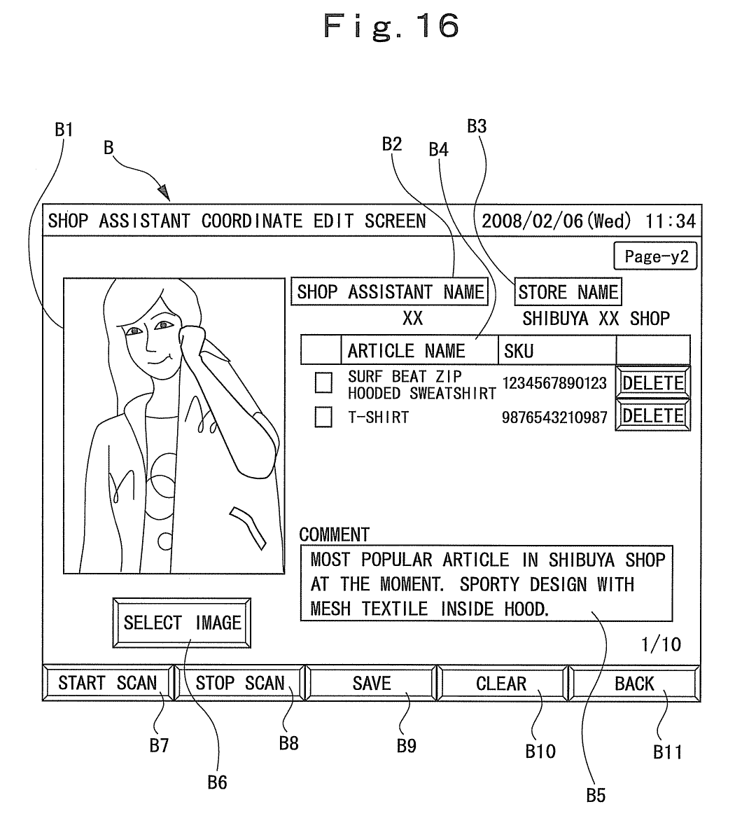

As shown in FIG. 14, the CPU 202 executes display of a coordinate edit screen B (see FIG. 15 and FIG. 16) (Act 102).

FIG. 15 is a schematic view showing an exemplary coordinate edit screen B displayed on the liquid crystal display 103 of the information terminal 101. The coordinate edit screen B shows an image display area B1, a shop assistant name display area B2, a store name display area B3, an article name display area B4, a comment input section B5, an image selection button B6, a scan start button B7, a scan stop button B8, a save button B9, a clear button B10, and a back button B11.

The image display area B1 is an area displaying a coordinate image, which is a picked-up image outputted by the camera 107 and taken in by the microcomputer 201. If the scan start button B7 or the scan stop button B8 is touched and designated, the CPU 202 executes image pickup by the camera 107. In short, if the scan start button B7 is touched and designated, the CPU 202 executes image pickup by the camera 107 and displays the picked-up image as a dynamic image in the image display area B1. If the scan stop button B8 is touched and designated, the CPU 202 takes in image data at that moment and displays a coordinate image as a still image in the image display area B1. The shop assistant selects and coordinates several pieces of clothes which are articles sold at the store. After that, the shop assistant puts on these articles coordinated by the shop assistant himself or herself, and enters the image pickup range of the camera 107 of the information terminal 101. Then, the shop assistant picks up an image of the shop assistant himself or herself wearing the coordinated clothes.

The shop assistant name display area B2 is an area displaying the name of the shop assistant. Data of the name in this case is the name of the shop assistant acquired by searching the shop assistant master area 222 (see FIG. 6) with the shop assistant code as a key. In this case, the CPU 202 can acquire the information of the store to which the shop assistant belongs, from the shop assistant master area 222, and therefore, displays the acquired information of the store to which the shop assistant belongs, in the store name display area B3.

The article name display area B4 is an area displaying the article name selected by the shop assistant.

The comment input section B5 allows comments to be written therein. The CPU 202 causes the liquid crystal display 103 of the information terminal 101 to display a keyboard and enables input of comments by using the displayed keyboard.

The save button B9, the clear button B10 and the back button B11 are objects to be touched to designate saving, clearing, and returning the processing, respectively.

As shown in FIG. 14, after executing display of the coordinate edit screen B shown in Act 102, the CPU 202 stands by for camera image pickup (Act 103). As image data of a coordinate image is acquired, the CPU 202 decides an image ID for the acquired image data and temporarily stores this image data in the RAM 205. Then, the CPU 202 drive-controls the video controller 207 so as to display the coordinate image (Act 104). The video controller 207 displays the image data in the image display area B1 of the coordinate edit screen B (Act 105).

After displaying the coordinate edit screen B (Act 105), the CPU 202 starts the RFID reader writer 210 (Act 106). After that, the CPU 202 determines the event type (Act 107).

The shop assistant wearing the coordinated article ATL is close to the information terminal 101. Therefore, the RFID reader writer 210 can scan both the article code of the coordinated article ATL and the shop assistant code on the ID card held by the shop assistant. The RFID reader writer 210 receives the shop assistant code from the ID card held by the shop assistant, receives the article code from the article tag AT attached to the article ATL, and outputs the received identification code and article code.

If the CPU 202 determines in Act 107 that input data is data output from the RFID reader writer 210, the CPU 202 determines in Act 108 whether the input data is a shop assistant code or an article code.

If the CPU 202 determines the shop assistant ID in Act 108, the CPU 202 executes processing of Act 109. That is, the CPU 202 searches for and acquires the name of the shop assistant and the store to which the shop assistant belongs, from the shop assistant master area 222 by using the shop assistant ID that is taken in as a key. The CPU 202 then displays the acquired name of the subject in the shop assistant name display area B2 of the coordinate edit screen B and displays the store to which the shop assistant belongs, in the store name display area B3. After that, the CPU 202 returns to processing of Act 106.

If the CPU 202 determines the article ID in type determination in Act 108, the CPU 202 executes processing of Act 110. That is, the CPU 202 searches for and acquires the article name from the article master area 221 by using the article ID that is taken in as a key, and displays the acquired article name in the article name display area B4 of the coordinate edit screen B. After that, the CPU 202 returns to processing of Act 106.

FIG. 16 is a schematic view showing an exemplary coordinate edit screen B after various kinds of information are inputted at the information terminal 101.

As shown in FIG. 14, if the CPU 202 determines touch-designation of the save button B9 on the touch panel 105 in event type determination in Act 107, the CPU 202 executes registration of coordinate information including image data. As registration of coordinate information, the CPU 202 executes registration of a picked-up image (Act 114). That is, the CPU 202 saves and registers the image data of the picked-up image from the camera 107 or the like that is taken in Act 103, to the meta image accumulation area 225 shown in FIG. 8 together with the image ID. In this case, the CPU 202 also saves and registers the path names accompanying the image data of the picked-up image from the camera 107 or the like and existing image data into the meta image accumulation area 225 in association with the image ID and the coordinate image. Then, the CPU 202 sets a new ID code as a coordinate ID in the coordinate information area 226 shown in FIG. 9 and saves and registers the image ID, the article ID and the shop assistant ID in association with the ID code. In this case, the CPU 202 saves and registers item information including an article name searched for from the article ID, and shop assistant information including a shop assistant name and a store name searched for from the shop assistant ID, into the coordinate information area 226.

As shown in FIG. 14, if the CPU 202 determines the generation of another event in event type determination in Act 107, the CPU 202 executes corresponding processing (Act 116) and returns to Act 102.

### 3. Coordinate Information Browse Phase

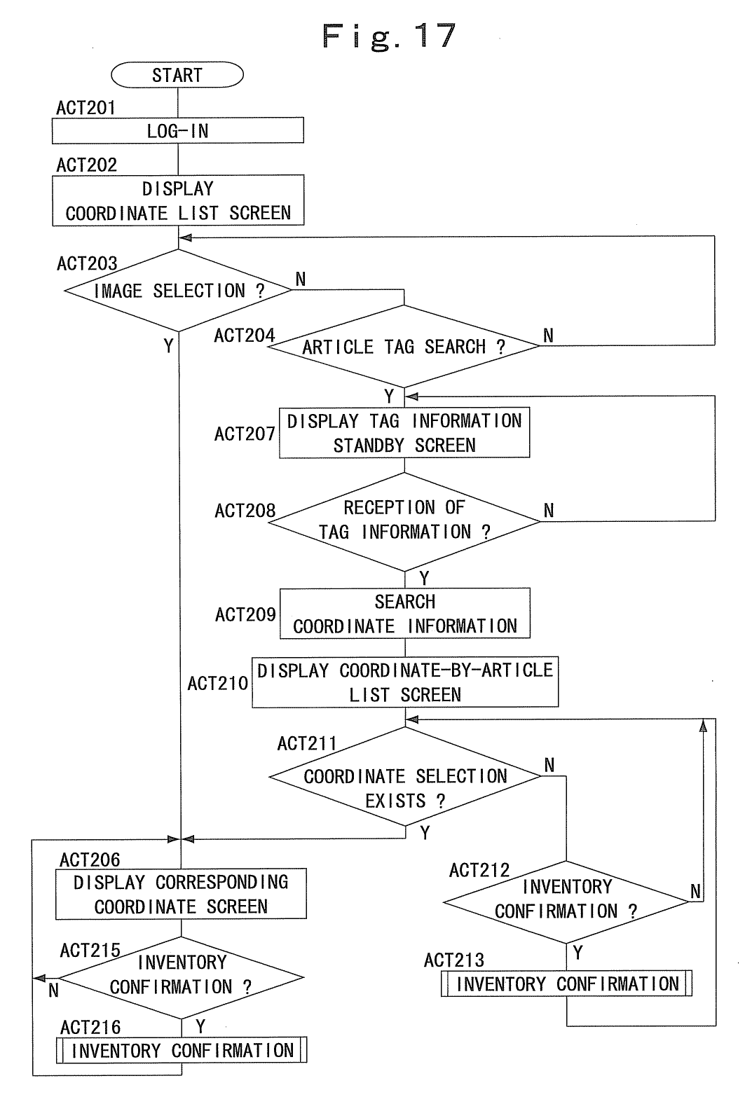

FIG. 17 is a flowchart showing the flow of coordinate information browse. Computer programs installed in the program area PA of the HDD 208 include a program for coordinate information browse in order to browse coordinate information accumulated and registered in the meta image accumulation area 225 and the coordinate information area 226.

If a customer visiting the store S wishes to browse coordinate images, the customer needs to log in at the information terminal 101. To log in at the information terminal 101, the customer causes the RFID reader writer 210 to scan the member card held by the customer. The microcomputer 201 searches the customer master area 223 by using the customer code outputted from the RFID reader writer 210 and determines whether the same customer ID exists or not. The microcomputer 201 authorizes log-in on condition that the same customer ID as the customer code scanned from the member card exists in the customer master area 223. This is log-in processing (Act 201).

When a shop assistant logs in at the information terminal 101, the shop assistant causes the RFID reader writer 210 to scan the ID card shop assistant code held by the shop assistant. The microcomputer 201 searches the shop assistant master area 222 by using the shop assistant code outputted from the RFID reader writer 210 and determines whether the same shop assistant ID as the shop assistant code exists or not. The microcomputer 201 authorizes log-in on condition that the same shop assistant ID as the shop assistant code scanned from the ID card held by the shop assistant exists in the shop assistant master area 222. This is log-in processing by the shop assistant (Act 201).

After executing log-in processing in Act 201, the microcomputer 201 displays and outputs a coordinate list screen D on the liquid crystal display 103 (Act 202).

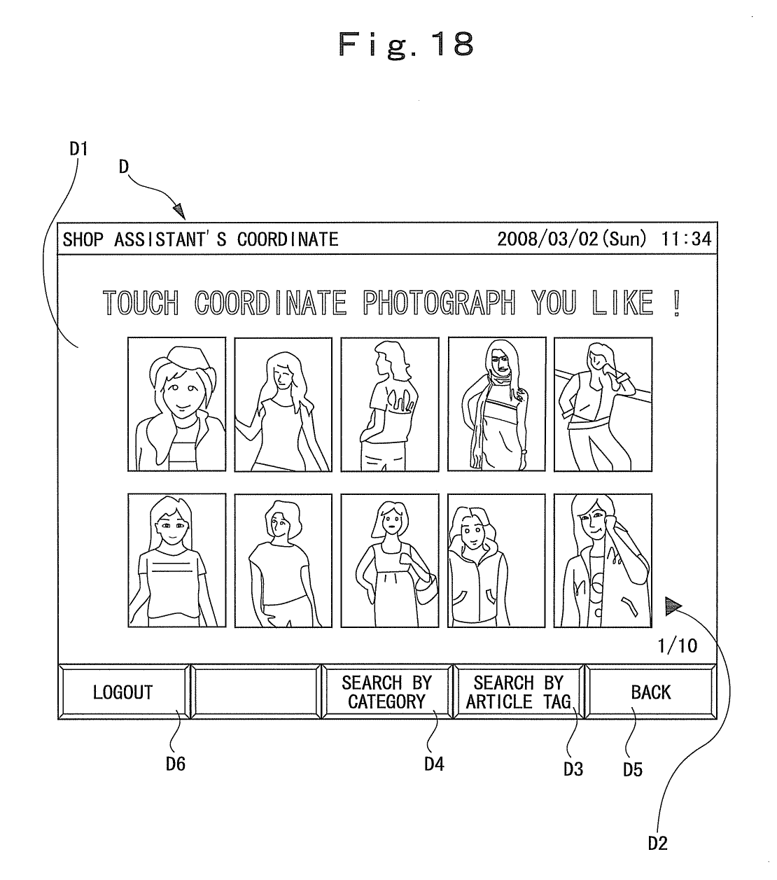

FIG. 18 is a schematic view showing an exemplary coordinate list screen D displayed on the liquid crystal display 103 of the information terminal 101. The coordinate list screen D mainly includes a list display section D1 in which 10 coordinate photographs are displayed in a list. The 10 coordinate photographs displayed in the list display section D1 can be scrolled by a scroll button D2.

In the coordinate list screen D, an article tag selection button D3 is displayed which shows “search by article tag”.

To search the coordinate list screen D for a desired coordinate image, the information terminal 101 provides two ways of search.

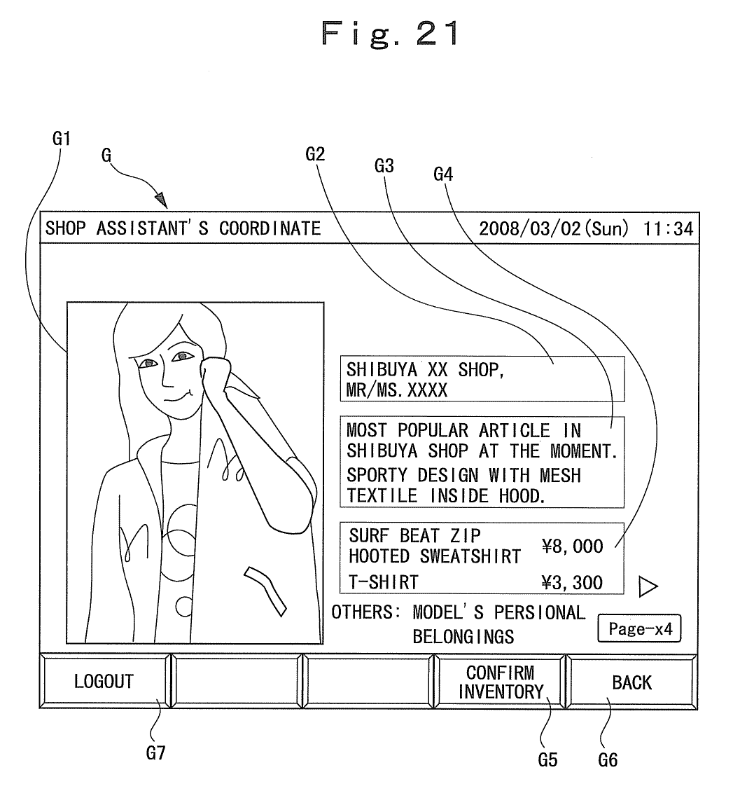

The first way of search is to select a coordinate image displayed in the list display section D1 by touch designation. As processing that follows Act 202, the CPU 202 of the information terminal 101 stands by for determination of presence or absence of image selection (Act 203). The coordinate images displayed as a list in the list display section D1 are coordinate images in the meta image accumulation area 225 shown in FIG. 8. By referring to the meta image accumulation area 225 with a selected coordinate image, the CPU 202 can search for the image ID corresponding to that coordinate image. Once the image ID is found, the CPU 202 can search for the coordinate ID by referring to the coordinate information area 226 shown in FIG. 9. Thus, the CPU 202 displays a coordinate screen G (see FIG. 21) including the coordinate image corresponding to the found coordinate ID, on the liquid crystal display 103 (Act 206).

The second way of search is to search on the basis of an article tag AT started by touching and designating the article tag selection button D3. As the article tag selection button D3 is touched and designated (Y in Act 204), the CPU 202 of the information terminal 101 displays a tag information standby screen E on the liquid crystal display 103 (Act 207).

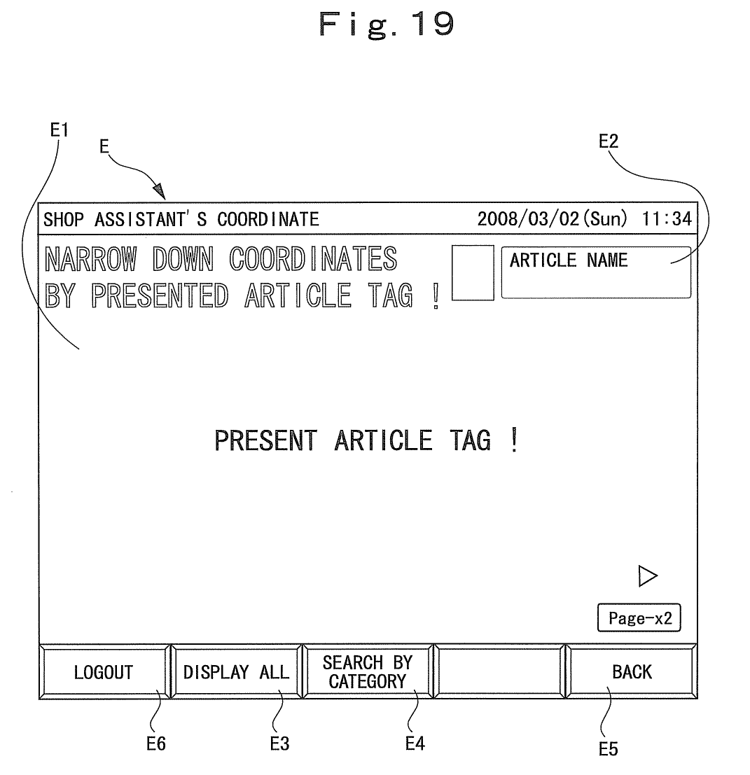

FIG. 19 is a schematic view showing an exemplary tag information standby screen E displayed on the liquid crystal display 103 of the information terminal 101. The tag information standby screen E shows a message E1 “Present article tag!” and shows an article name display section E2 for displaying the article name.

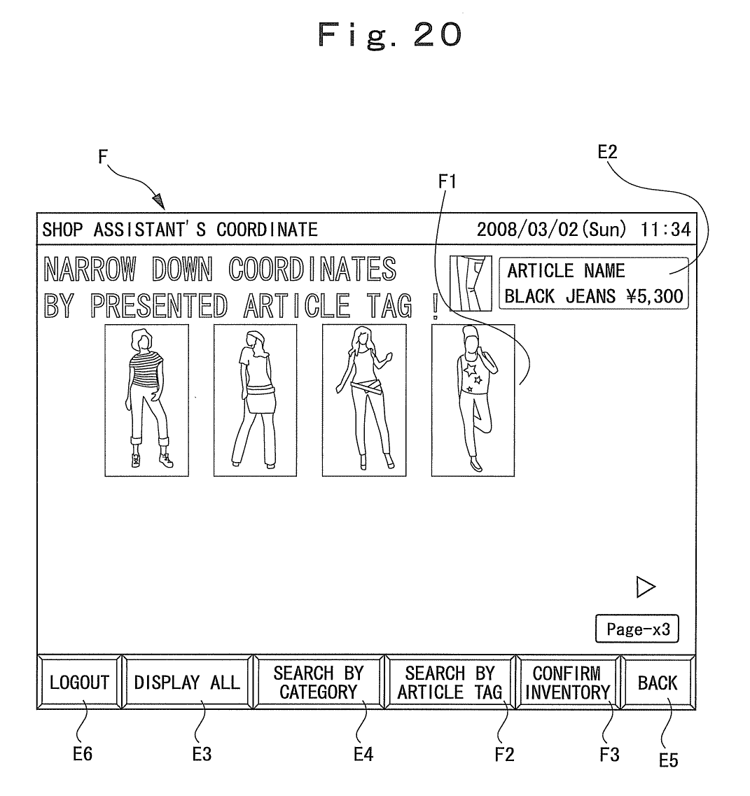

Back to the description of the flowchart shown in FIG. 17, after displaying the tag information standby screen E (Act 207), the CPU 202 of the information terminal 101 stands by for determination about reception of tag information (Act 208). The customer presents the article ATL for which the customer wants to see the shop assistant's coordinate image. As the RFID reader writer 210 scans and outputs the article code from the article tag AT, the CPU 202 determines reception of tag information (Y in Act 208). Next, the CPU 202 searches the coordinate information area 226 for the same article ID as the received article code (Act 209) and displays and outputs a coordinate-by-article list screen shown in FIG. 20 on the liquid crystal display 103 (Act 210).

As shown in FIG. 20, the coordinate-by-article list screen F shows, in the article name display section E2, the article name searched for from the article master area 221 on the basis of the article code that is determined as being received in Act 208. The coordinate-by-article list screen F also shows various coordinate images of the article registered in the meta image accumulation area 225.

Back to the description of the flowchart shown in FIG. 17, after displaying the coordinate-by-article list screen F (Act 210), the CPU 202 of the information terminal 101 stands by for determination about presence or absence of coordinate selection (Act 211) and determination about presence or absence of inventory confirmation designation (Act 212).

Coordinate selection is carried out by touching and designating a coordinate image displayed in the coordinate-by-article list screen F. The CPU 202 of the information terminal 101 finds the image ID corresponding to the designated coordinate image from the meta image accumulation area 225 and finds the coordinate ID corresponding to the image ID from the coordinate information area. The CPU 202 of the information terminal 101 displays a coordinate screen G including the coordinate image corresponding to the coordinate ID that is found, on the liquid crystal display 103 (Act 206).

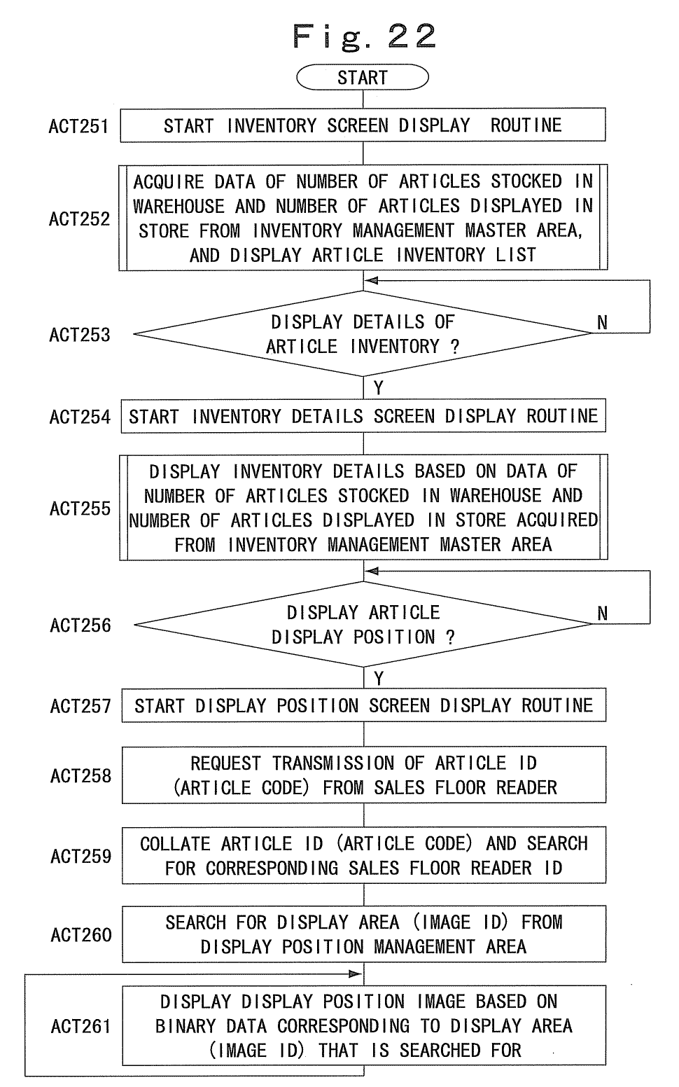

Inventory confirmation designation is carried out by touching and designating an inventory confirmation button F3 (Act 213). Inventory confirmation will be described later with reference to FIG. 22 to FIG. 27.

FIG. 21 is a schematic view showing an exemplary coordinate screen G displayed on the liquid crystal display 103 of the information terminal 101. The coordinate screen G secures display areas such as a coordinate image display area G1 for displaying a coordinate image, a shop assistant information display area G2, a comment display area G3, and an article information display area G4. These display areas show information that is searched for from the coordinate information area 226 shown in FIG. 9. The comment display area G3 shows text information recorded as comments in the coordinate information area 226.

Back to the description of the flowchart shown in FIG. 17, after displaying the coordinate screen (Act 206), the CPU 202 of the information terminal 101 stands by for determination about presence or absence of inventory confirmation designation (Act 215). Inventory confirmation designation is carried out by touching and designating an inventory confirmation button G5 (Act 216). Inventory confirmation will be described later with reference to FIG. 22 to FIG. 27.

### 4. Inventory Confirmation Phase

FIG. 22 is a flowchart showing the flow of inventory confirmation. The processing shown in the flowchart of FIG. 22 shows the details of inventory confirmation of Act 213 and Act 216 in the flowchart of FIG. 17.

As inventory confirmation, the CPU 202 of the information terminal 101 first starts an inventory screen display routine (Act 251). This routine is described in a program installed in the program area PA of the HDD 208. As the inventory screen display routine is started, the CPU 202 of the information terminal 101 displays an inventory screen H on the liquid crystal display 103. The CPU 202 acquires the article code of the article ATL from the coordinate information area 226 by using the coordinate ID acquired by selection designation of the coordinate image determined in Act 203 or Act 211. The CPU 202 acquires data of the number of articles displayed in the sales floor and the number of articles stocked in the warehouse from the inventory management master area 227 (see FIG. 10) by using the acquired article code. The CPU 202 also searches the inventory management master area 227 by using an article code that is partly the same as the acquired article code. Then, the CPU 202 acquires data of the number of articles displayed in the sales floor and the number of articles stocked in the warehouse with respect to the article code that is partly the same as the acquired article code. These article codes refer to the same article name with different sizes and colors.

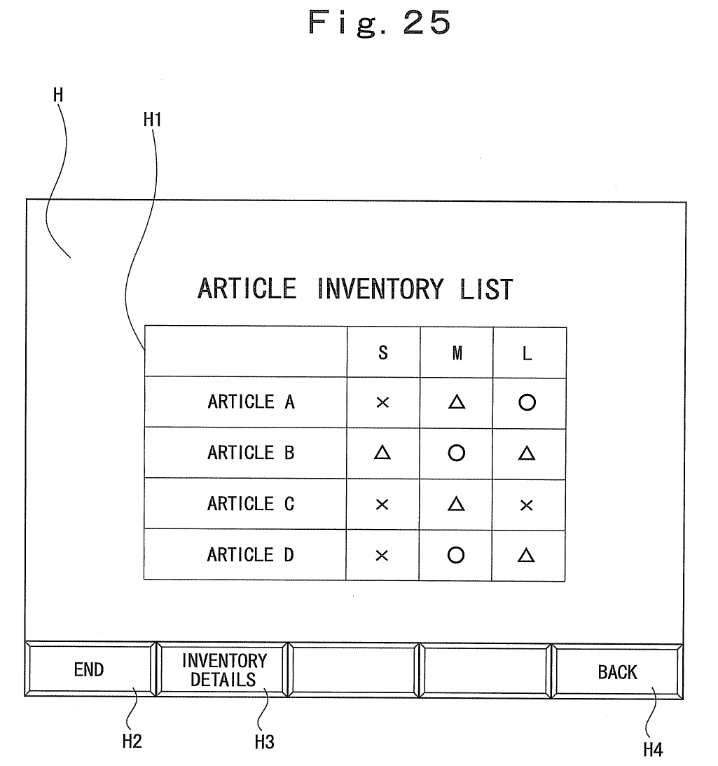

The CPU 202 of the information terminal 101 displays inventory information in the form of an article inventory list H1 in the inventory screen H (Act 252). The article inventory list H1 shows a matrix containing items and sizes of the clothes as the article ATL. In the example shown in FIG. 25, there are four items “article A”, “article B”, “article C” and “article D”, and three sizes “S”, “M” and “L”. The four items are the same clothes in different colors having different but partly common article codes.

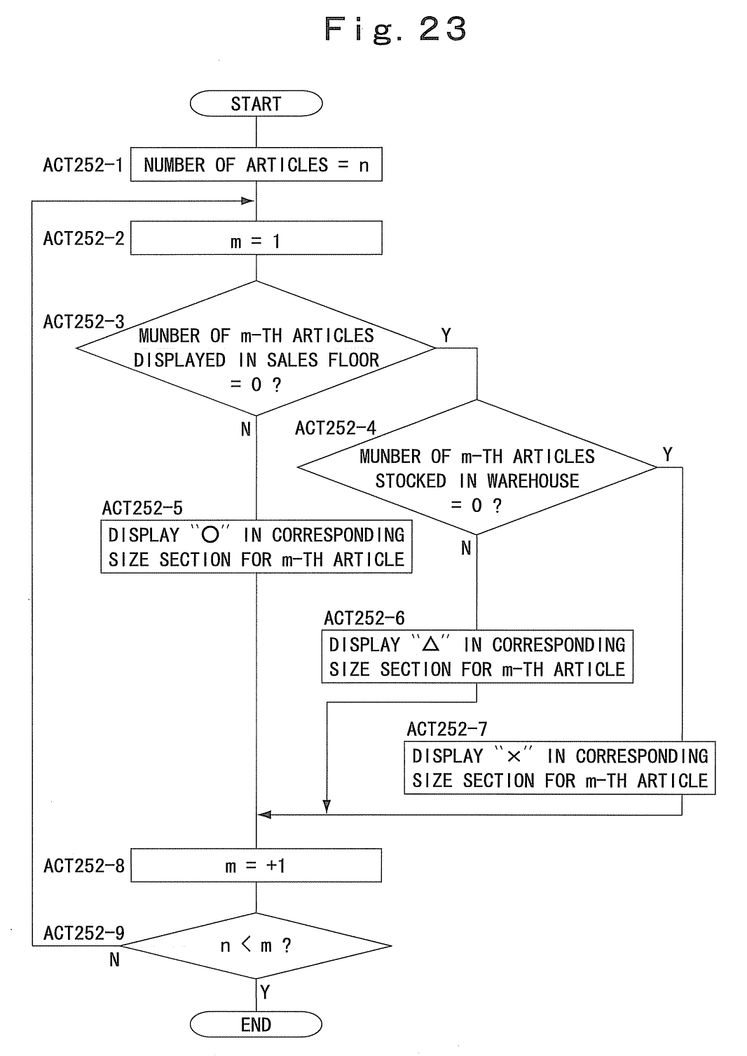

FIG. 23 is a flowchart showing the flow of displaying the article inventory list H1. This flowchart shows the details of the display of the article inventory list Hi in Act 252 in the flowchart of FIG. 22. The CPU 202 of the information terminal 101 assumes that the number of articles is n (Act 252-1). For example, if the clothes that is actually coordinated in the coordinate image shown in the coordinate screen G (see FIG. 21) includes four items “article A”, “article B”, “article C” and “article D” and article IDs (article codes) corresponding to sizes “S”, “M” and “L” for each article are registered in the coordinate information area 226, the number of articles assumed to be n in Act 252-1 is 12.

Next, the CPU 202 of the information terminal 101 assumes m indicating the order of the article is 1 (Act 252-2).

Then, the CPU 202 determines whether the number of the m-th articles ATL displayed in the sales floor S1 is 0 or not (Act 252-3) and determines whether the number of the m-th articles ATL stocked in the warehouse S2 is 0 or not (Act 252-4).

If the CPU 202 determines that the number of the m-th articles ATL displayed in the sales floor S1 is not 0 (N in Act 252-3), the CPU 202 displays “O” in the corresponding size section for the corresponding item in the article inventory list H1 (Act 252-5).

If the CPU 202 determines that the number of the m-th articles ATL stocked in the warehouse S2 is not 0 (N in Act 252-4), the CPU 202 displays “Δ” in the corresponding size section for the corresponding item in the article inventory list H1 (Act 252-6).

If the CPU 202 determines that the number of the m-th articles ATL stocked in the warehouse S2 is 0 (Y in Act 252-4), the CPU 202 displays “X” in the corresponding size section for the corresponding item in the article inventory list Hi (Act 252-7).

After that, the CPU 202 of the information terminal 101 increments m by one (Act 252-8) and then determines whether n<m holds or not (Act 252-9). This is to determine whether inventory information display in the corresponding size section for the corresponding item in the article inventory list H1 is finished with respect to all the number of articles n set in Act 252-1.

If the CPU 202 of the information terminal 101 determines that n<m does not hold (N in Act 252-9), the CPU 202 returns to processing of Act 252-2. If it is determined that n<m holds (Y in Act 252-9), the CPU 202 ends the processing shown in the flowchart.

FIG. 25 is a schematic view showing an exemplary inventory screen H. In FIG. 25, “article A”, “article B”, “article C” and “article D” represent clothes that are coordinated in the coordinate image. In this case, “article A”, “article B”, “article C” and “article D” may be different kinds of clothes or may be the same clothes in different colors. Moreover, “S”, “M” and “L” refer to different sizes of the same article ATL. In the article master area 221, different colors and different sizes for the same article are managed by different article codes that are partly the same. Thus, the same articles in different colors can be distinguished in their display, for example, as “article A” and “article B”, and the same articles with different sizes can be distinguished in their display as “S”, “M” and “L”.

The inventory screen H shows an end button H2, a inventory details button H3, and a back button H4 as command objects that can be touched and designated on the touch panel 105, in addition to the article inventory list H1.

Back to the description of the flowchart shown in FIG. 22, the CPU 202 of the information terminal 101 stands by for presence or absence of touch-designation of the inventory details button H3 (Act 253). Selection of one article can be carried out by touch-designation on the touch panel 105. As such touch-designation of one article is done and the inventory details button H3 is subsequently touched and designated, the CPU 202 determines the presence of touch-designation of the inventory details button H3 (Y in Act 253).

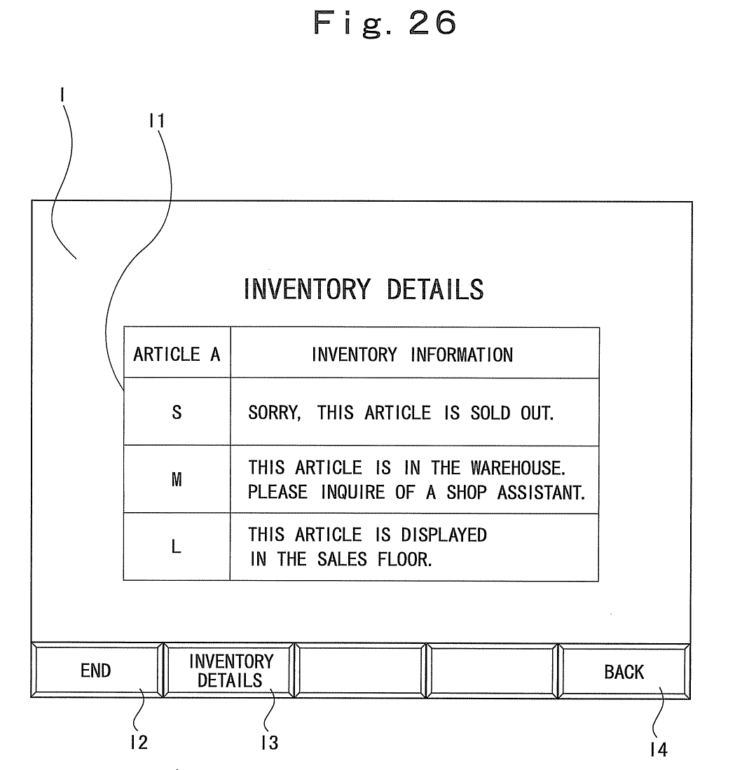

If the CPU 202 of the information terminal 101 determines the presence of touch-designation of the inventory details button H3 (Y in Act 253), the CPU 202 starts an inventory details screen display routine (Act 254). This routine is described in a program installed in the program area PA of the HDD 208. As the inventory details screen display routine is started, the CPU 202 of the information terminal 101 displays the frame of an inventory details screen I on the liquid crystal display 103. Then, the CPU 202 displays inventory details I1 (see FIG. 26) of the selected and designated article in the inventory details screen I on the basis of the data of the number of articles displayed in the sales floor and the number of articles stocked in the warehouse acquired from the inventory management master area 227 by the processing of Act 252.

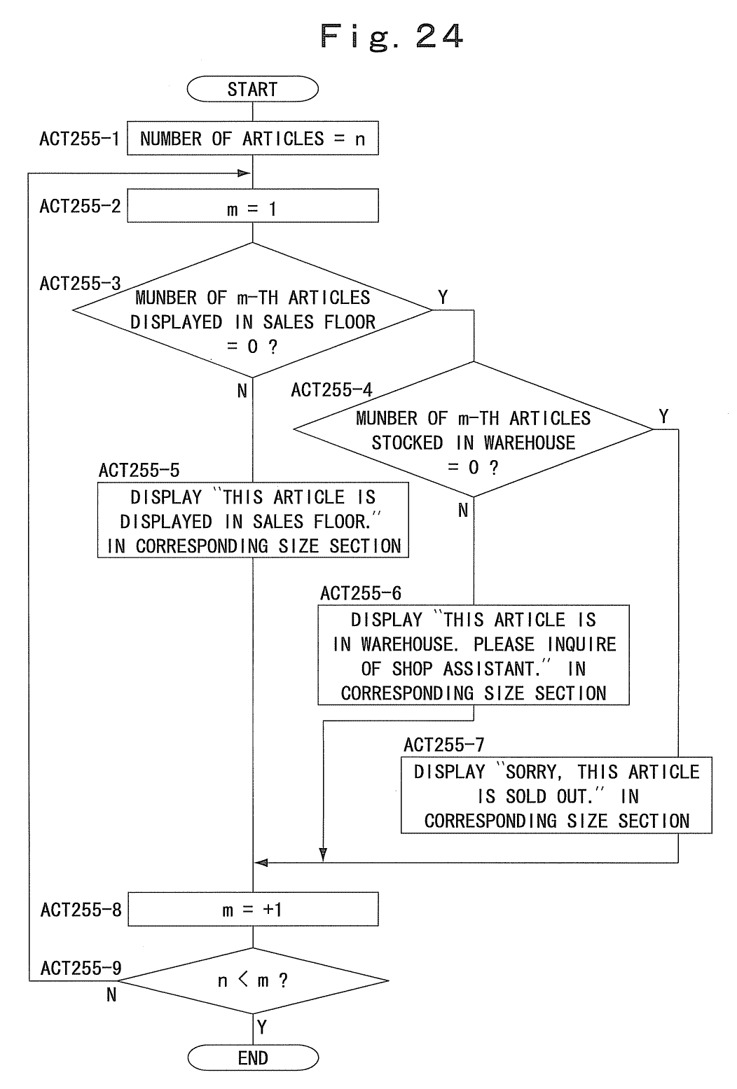

FIG. 24 is a flowchart showing the flow of displaying the inventory details I1. This flowchart shows the details of the display of the inventory details I1 in Act 255 in the flowchart of FIG. 22. The CPU 202 of the information terminal 101 assumes that the number of articles is n (Act 255-1). For example, in FIG. 25, if the article A is designated, the number of articles is 3.

Next, the CPU 202 of the information terminal 101 assumes that m indicating the order of the article is 1 (Act 255-2).

Then, the CPU 202 of the information terminal 101 determines whether the number of the m-th articles ATL displayed in the sales floor S1 is 0 or not (Act 255-3) and determines whether the number of the m-th articles ATL stocked in the warehouse S2 is 0 or not (Act 255-4).

If the CPU 202 determines that the number of the m-th articles ATL displayed in the sales floor S1 is not 0 (N in Act 255-3), the CPU 202 displays “This article is displayed in the sales floor.” in the corresponding size section in the inventory details I1 (Act 255-5).

If the CPU 202 determines that the number of the m-th articles ATL stocked in the warehouse S2 is not 0 (N in Act 255-4), the CPU 202 displays “This article is in the warehouse. Please inquire of a shop assistant.” in the corresponding size section in the inventory details I1 (Act 255-6).

If the CPU 202 determines that the number of the m-th articles ATL stocked in the warehouse S2 is 0 (Y in Act 255-4), the CPU 202 displays “Sorry, this article is sold out.” in the corresponding size section in the inventory details I1 (Act 255-7).

After that, the CPU 202 of the information terminal 101 increments m by one (Act 255-8) and then determines whether n<m holds or not (Act 255-9). This is to determine whether inventory information display in the corresponding size section in the inventory details I1 is finished with respect to all the number of articles n set in Act 255-1.

If the CPU 202 of the information terminal 101 determines that n<m does not hold (N in Act 255-9), the CPU 202 returns to processing of Act 255-2. Meanwhile, if it is determined that n<m holds (Y in Act 255-9), the CPU 202 ends the processing shown in the flowchart.

FIG. 26 is a schematic view showing an exemplary inventory details screen I. In FIG. 26, an example of displaying inventory details I1 for “article A” is shown. Inventory information for size “S” is “Sorry, this article is sold out.” This corresponds to “X” in the article inventory list H1 displayed in the inventory screen H shown in FIG. 25 and indicates that the article is stocked neither in the sales floor S1 nor in the warehouse S2. Inventory information for size “M” is “This article is in the warehouse. Please inquire of a shop assistant.” This corresponds to “Δ” in the article inventory list Hi displayed in the inventory screen H shown in FIG. 25 and indicates that the article is not displayed in the sales floor S1 but is stocked in the warehouse S2. Inventory information for size “L” is “This article is displayed in the sales floor.” This corresponds to “O” in the article inventory list H1 displayed in the inventory screen H shown in FIG. 25 and indicates that the article is displayed in the sales floor S1.

Back to the description of the flowchart shown in FIG. 22, the CPU 202 of the information terminal 101 stands by for presence or absence of touch-designation of a position information button I3 (Act 256), following the processing of Act 255. As the position information button I3 is touched and designated, the CPU 202 determines the presence of touch-designation of the position information button I3 (Y in Act 256).

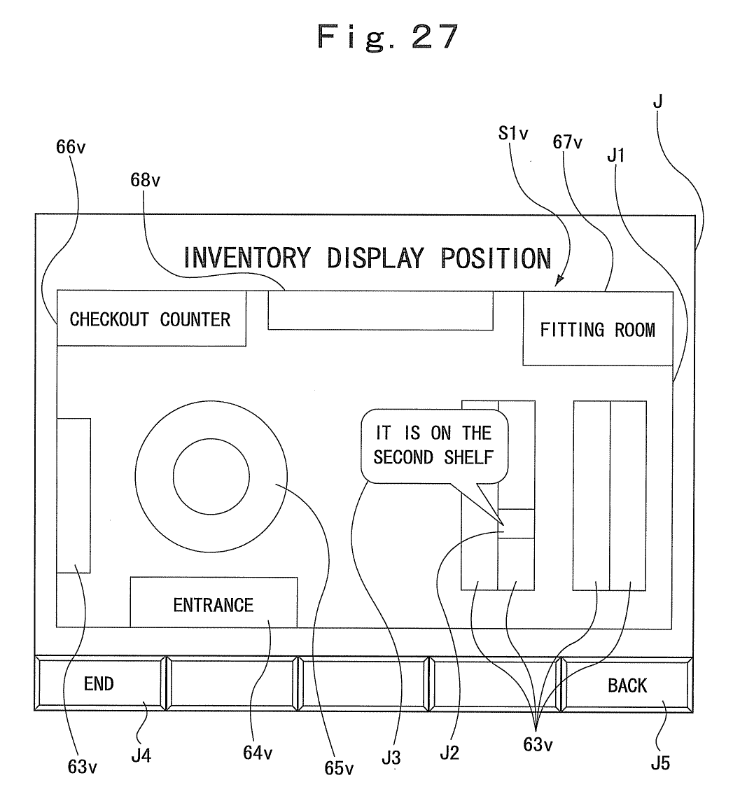

If the CPU 202 of the information terminal 101 determines the presence of touch-designation of the position information button I3 (Y in Act 256), the CPU 202 of the information terminal 101 starts a position information display routine (Act 257). This routine is described in a program installed in the program area PA of the HDD 208. As the position information display routine is started, the CPU 202 of the information terminal 101 displays the frame of a display position screen J (see FIG. 27) on the liquid crystal display 103. Then, the CPU 202 of the information terminal 101 outputs a command to request transmission of the article ID (article code) from all the sales floor readers 73 arranged on the display rack 63 installed in the sale floor S1 (Act 258).

Then, the individual sales floor readers 73 acquire the article code of the article tag AT attached to the article ATL arranged within their respective scanning ranges. Then, all the acquired article codes are added to the sales floor reader ID and transmitted to the information terminal 101 via the local area network 153.

Thus, the CPU 202 of the information terminal 101 displays inventory details I1 as the inventory details screen I selected and designated from the inventory screen H and collates the article ID (article code) of the article ATL for which display of its display position screen J is demanded, with the article ID (article code) received from each sales floor reader 73 (Act 259). That is, in this processing of Act 259, the CPU 202 searches for the IP address (sales floor reader ID) of the sales floor reader 73 which transmits the same article ID (article code) as the article ID (article code) of the article ATL for which display of the display position screen J is demanded. Thus, the sales floor reader 73 which scans the RFID chip contained in the article tag AT attached to the article ATL for which display of the display position screen J is demanded, is specified.

Then, the information terminal 101 executes processing to search for the arrangement position of the specified sales floor reader 73. That is, the CPU 202 accesses the display position management area 228 (FIG. 11) and acquires the display area (image ID) associated with the IP address (sales floor reader ID) that is searched for and acquired in the processing of Act 259, as a key (Act 260). Next, the CPU 202 searches the display position image area 229 by using the image ID and acquires an arrangement position image (Act 261). In the processing of Act 261, the CPU 202 displays a display position display J1 in the display position screen J. As a result, it becomes possible to visually show the user browsing at the information terminal 101 the position of the article ATL selected by this user.

FIG. 27 is a schematic view showing an exemplary display position screen J. In the display position screen J, the display position display J1 is shown. In FIG. 27, S1v represents the sales floor S1, 63v represents the display rack 63, 64v represents an entrance 64, 65v represents a display booth 65, and 66v represents a checkout counter 66.

In the display position display J1 shown in FIG. 27, a mark J2 is shown in a part of the display rack image 63v in the third column from the right, and a balloon J3 containing “There is the article on the second shelf” is shown as coming out of the mark J2. The user browsing the display position screen J at the information terminal 101 can learn that the article ATL selected by the user is placed in the position indicated by the mark J2 and described by the balloon J3.

### 7. Effects of Store System According to This Embodiment

Whether an article ATL which is clothes selected from coordinate images is carried into and exists in the sales floor S1, or is in the warehouse S2 attached to the store S, or is sold out without any stock, can be shown in the inventory screen H. Thus, the status of the article ATL in the sales floor S1 and the warehouse S2 attached to the sales floor S1 can be accurately presented.

In response to actual increase and decrease in the number of articles ATL in the warehouse S2 and the sales floor S1, the management contents of the increase and decrease can be adapted in the inventory database without requiring manual operation input. Thus, labor saving for operation input can be realized in update management of the inventory database.

Moreover, the place in the sales floor S1 where the desired target article ATL is roughly located can be visually shown to the user browsing the display position screen J. Thus, the customer can be easily notified of where in the sales floor S1 the customer's target article ATL exists, and sales promotion, reduction in labor of shop assistants and the like can be realized.

### 8. Other Examples (I)

A display rack having one shelf or plural shelves to display clothes on, or a drawer housing clothes may be provided, and antennas for short-range wireless communications may be arranged at plural positions on the display rack or in the drawer. The RFID reader executes short-range wireless communication with the RFID chip contained in the article tag AT attached to an article ATL displayed on the display rack or housed in the drawer, and acquires the article code from each article tag AT.

### 9. Other Examples (II)

All or part of the various areas (221 to 229) installed in the HDD 208 of the information terminal 101 may be provided, for example, in the HDD 258 of the POS terminal 151. Alternatively, a server (not shown) may be installed in the store S and all or part of the various areas (221 to 229) maybe provided in this server.

As described above, the system according to the embodiment can show whether an article which is clothes selected from coordinate images is carried into and exists in the sales floor, or is in the warehouse attached to the store, or is sold out without any stock, in the inventory screen. Thus, the status of the article in the sales floor and the warehouse attached to the sales floor can be accurately presented to the user.

Obviously, numerous modifications and variations of the present invention are possible in light of the above teachings. It is therefore to be understood that within the scope of the appended claims, the invention may be practiced otherwise than as specifically described herein.

What is claimed is:

1. An information providing device comprising:
a display unit for displaying information;
an operation input unit for carrying out operation input of information; and
a controller which executes processing to:
acquire data of a coordinate image from a coordinate database which stores and saves a coordinate image formed by picking up an image of coordinated clothes as an article in association with an articles code of the coordinated clothes in the coordinate image;
display a coordinate screen including the acquired coordinate image on the display unit;
acquire data of an article code of the coordinated clothes in the coordinate image included in the coordinate screen, from the coordinate database;
acquire data of inventory status in a warehouse and data of display status in a sales floor associated with the acquired article code, from an inventory database which stores and saves an article code of an individual article in association with inventory status of the article in a warehouse and display status of the article in a sales floor; and
display, on the display unit, an inventory screen which reports a place where the article exists on the basis of the acquired data of inventory status and display status.

2. The device of claim 1, wherein if the acquired data of the display status in the sales floor indicates that there is a displayed article, the controller only displays the display information in the sales floor on the inventory screen without displaying the inventory information in the warehouse, and if the acquired data of the display status in the sales floor indicates that there is no article displayed, the controller only displays the inventory information in the warehouse on the inventory screen without displaying the display information in the sales floor.

3. The device of claim 1, wherein the controller executes processing to:
allow a display designation of display position of the selected and designated clothes by the operation input unit;
output a command to request transmission of an article code to plural sales floor readers as RFID readers which are installed at plural positions on a display rack for displaying clothes in the sales floor and acquire an article code from a wireless tag attached to clothes via short-range wireless communication in accordance with the display designation of display position;
search a display position definition which stores each of the sales floor readers and a display position in association with each other, and acquires the display position associated with the sales floor reader transmitting the acquired article code; and
display the acquired display position on the display unit.

4. The device of claim 1, wherein the controller executes processing to:
allow a display designation of a display position of the selected and designated clothes by the operation input unit;
output a command to request transmission of an article code to a smart shelf containing a sales floor reader as an RFID reader which acquires an article code, by using an antenna arranged at plural positions on a display rack having one or plural shelves to display clothes on, from a wireless tag attached to clothes displayed on the display rack via short-range wireless communication, and transmits and outputs the acquired article code by each of the antennas, in accordance with the display designation of display position;
search a display position definition which stores each of the antennas and a display position in association with each other, and acquires the display position associated with the antenna prescribing the unit of the transmitted and outputted article code; and
display the acquired display position on the display unit.

5. A computer-readable medium having a computer program stored thereon which, when executed by a computer, will cause the computer to:
acquire data of a coordinate image from a coordinate database which stores and saves a coordinate image formed by picking up an image of coordinated clothes as an article in association with an articles code of the coordinated clothes in the coordinate image;
display a coordinate screen including the acquired coordinate image on the display unit;
acquire data of an article code of the coordinated clothes in the coordinate image included in the coordinate screen, from the coordinate database;
acquire data of inventory status in a warehouse and data of display status in a sales floor associated with the acquired article code, from an inventory database which stores and saves an article code of an individual article in association with inventory status of the article in a warehouse and display status of the article in a sales floor; and
display, on the display unit, an inventory screen which reports a place where the article exists on the basis of the acquired data of inventory status and display status.

6. A store system comprising:
an entrance reader which is installed at an entrance of a warehouse, has a data communication function with an external device, and acquires an article code from a wireless tag attached to clothes via short-range wireless communication;
an exit reader which is installed at a doorway between the warehouse and a sales floor, has a data communication function with an external device, and acquires an article code from a wireless tag attached to clothes via short-range wireless communication; and
an information providing device including:
a display unit for displaying information;
an operation input unit for carrying out operation input of information;
a data communication unit which communicates data with the entrance reader and the exit reader; and
a controller which executes processing to:
if the information providing device receives an article code that is data-transmitted from the entrance reader, increment the number of articles stocked in the warehouse by one with respect to that article, as update management of an inventory database which stores and saves an article code of an individual article in association with the number of articles stocked in the warehouse and the number of articles displayed in the sales floor with respect to that article;
if the information providing device receives an article code that is data-transmitted from the exit reader, decrement the number of articles stocked in the warehouse by one and increment the number of articles displayed in the sales floor by one with respect to that article, as update management of the inventory database;
acquire data of a coordinate image from a coordinate database which stores and saves a coordinate image formed by picking up an image of coordinated clothes as an article in association with an articles code of the coordinated clothes in the coordinate image;
display a coordinate screen including the acquired coordinate image on the display unit;
acquire data of an article code of the coordinated clothes in the coordinate image included in the coordinate screen, from the coordinate database;
acquire data of inventory status in the warehouse and data of display status in the sales floor associated with the acquired article code, from the inventory database; and
display, on the display unit, an inventory screen which reports a place where the article exists on the basis of the acquired data of inventory status and display status.
